(19) United States
(12) Patent Application Publication
(10) Pub. No.: US 2024/0387916 A1
(43) Pub. Date: Nov. 21, 2024

(54) ENERGY STORAGE APPARATUS AND METHOD OF MANUFACTURING ENERGY STORAGE APPARATUS

(71) Applicant: GS Yuasa International Ltd., Kyoto-shi (JP)

(72) Inventors: Riku AIKATA, Kyoto-shi (JP); Ryoichi OKUYAMA, Kyoto-shi (JP)

(73) Assignee: GS Yuasa International Ltd., Kyoto-shi (JP)

(21) Appl. No.: 18/702,599

(22) PCT Filed: Oct. 4, 2022
(86) PCT No.: PCT/JP2022/037048

§ 371 Date: Apr. 18, 2024

(30) Foreign Application Priority Data
Oct. 21, 2021 (JP) 2021-172308

(51) Int. Cl. H01M 50/209; H01M 50/224; H01M 50/271; H01M 50/289

(52) U.S. Cl. CPC H01M 50/209; H01M 50/224; H01M 50/271; H01M 50/289

(57) ABSTRACT

An energy storage apparatus includes an energy storage unit including a plurality of energy storage devices each having a flat shape, and an outer case that accommodates the energy storage unit. The outer case includes an outer case body in which a first opening portion opened in a predetermined direction is formed, the outer case body includes a bottom wall facing the first opening portion in the predetermined direction, and a side wall integrated with the bottom wall, and a second opening portion through which the energy storage unit can pass is formed at a position facing the side wall of the outer case body.

### TECHNICAL FIELD

The present invention relates to an energy storage apparatus including a plurality of energy storage devices, and a method of manufacturing the energy storage apparatus.

### BACKGROUND ART

Conventionally, there has been widely known an energy storage apparatus which includes an energy storage unit including a plurality of energy storage devices each having a flat shape, and an outer case in which the energy storage unit is accommodated. For example, Patent Document 1 discloses a battery pack (energy storage apparatus) in which a battery group (energy storage unit) including a plurality of prismatic secondary batteries (energy storage devices having a flat shape) are accommodated in a case body and an upper cover (outer case).

### PRIOR ART DOCUMENT

### Patent Document

Patent Document 1: JP-A-2018-137191

### SUMMARY OF THE INVENTION

### Problems to be Solved by the Invention

In the energy storage apparatus having the above-mentioned conventional configuration, the energy storage unit in which a plurality of flat energy storage devices is arranged in a row is inserted from an opening portion that faces a bottom wall of an outer case body (case body) so that the energy storage unit is accommodated in the outer case. In this case, it may be difficult to insert the energy storage unit from the opening portion of the outer case body depending on a position, a shape and a size of the opening portion of the outer case body, a configuration of the energy storage unit, or the like. As described above, in the conventional energy storage apparatus, there is a case where the energy storage apparatus cannot be easily assembled, and a configuration that allows improvement in assemblability is desired.

The present invention has been made by the inventor of the present application focusing newly on the above problem, and an object of the present invention is to provide an energy storage apparatus which allows improvement in assemblability, and a method of manufacturing the energy storage apparatus.

### Means for Solving the Problems

An energy storage apparatus according to one aspect of the present invention is an energy storage apparatus including an energy storage unit including a plurality of energy storage devices each having a flat shape, and an outer case that accommodates the energy storage unit. The outer case includes an outer case body in which a first opening portion opened in a predetermined direction is formed, the outer case body includes a bottom wall facing the first opening portion in the predetermined direction, and a side wall integrated with the bottom wall, and a second opening portion through which the energy storage unit can pass is formed at a position facing the side wall of the outer case body.

A method of manufacturing an energy storage apparatus according to one aspect of the present invention is a method of manufacturing an energy storage apparatus including an energy storage unit including a plurality of energy storage devices each having a flat shape, and an outer case that accommodates the energy storage unit, the outer case including an outer case body in which a first opening portion opened in a predetermined direction is formed, the outer case body including a bottom wall facing the first opening portion in the predetermined direction, and a side wall integrated with the bottom wall. The method includes causing the energy storage unit to pass through a second opening portion formed at a position facing the side wall of the outer case body to accommodate the energy storage unit in the outer case.

### Advantages of the Invention

According to the energy storage apparatus and the like of the present invention, assemblability can be improved.

### BRIEF DESCRIPTION OF THE DRAWINGS

FIG. 1 is a perspective view illustrating a configuration of an energy storage apparatus according to an embodiment.

FIG. 2 is an exploded perspective view illustrating each constitution element of an energy storage unit according to the embodiment.

FIG. 3 is a perspective view illustrating a configuration of an energy storage device included in the energy storage unit according to the embodiment.

FIG. 4 is a perspective view illustrating a configuration of an outer case body included in an outer case according to the embodiment.

FIG. 5 is a diagram illustrating a process of accommodating the energy storage unit according to the embodiment inward of an outer case.

FIG. 6 is a perspective view illustrating a configuration of a lid body included in the outer case according to a first modification example of the embodiment.

### MODE FOR CARRYING OUT THE INVENTION

(1) An energy storage apparatus according to one aspect of the present invention is an energy storage apparatus including an energy storage unit including a plurality of energy storage devices each having a flat shape, and an outer case that accommodates the energy storage unit. The outer case includes an outer case body in which a first opening portion opened in a predetermined direction is formed, the outer case body includes a bottom wall facing the first opening portion in the predetermined direction, and a side wall integrated with the bottom wall, and a second opening portion through which the energy storage unit can pass is formed at a position facing the side wall of the outer case body.

According to the above, in the energy storage apparatus, the outer case body of the outer case in which the energy storage unit including the energy storage device having a flat shape is accommodated includes the first opening portion, and the bottom wall and the side wall which are integrated, and the second opening portion through which the energy storage unit can pass is formed at a position facing the side wall. As described above, in the outer case body, the second opening portion through which the energy storage unit can pass is formed at a position facing the side wall in addition to the first opening portion which is opened in a direction facing the bottom wall. By the above, even in a case where it is difficult to insert the energy storage unit from the first opening portion, the energy storage unit can be inserted from the second opening portion and hence, the energy storage apparatus can be easily assembled. Therefore, it is possible to improve assemblability of the energy storage apparatus.

(2) In the energy storage apparatus according to (1) described above, the bottom wall and the side wall may be integrally molded as one member by casting.

According to the above, the bottom wall and the side wall of the outer case body are integrally molded as one member and hence, man-hours for assembling the side wall can be reduced.

(3) In the energy storage apparatus according to (1) or (2) described above, the second opening portion may be an opening portion which opens in an arrangement direction of a plurality of the energy storage devices.

According to the above, since the second opening portion of the outer case body is opened in an arrangement direction of a plurality of the energy storage devices, the energy storage unit can be inserted from the second opening portion in the arrangement direction. By the above, in the energy storage unit, a plurality of the energy storage devices can be inserted into the inside of the outer case body without pressing and inserting a plurality of the energy storage devices in the arrangement direction. Therefore, since the energy storage apparatus can be easily assembled, assemblability of the energy storage apparatus can be improved.

(4) In the energy storage apparatus according to (3) described above, the second opening portion may be arranged at a position facing the energy storage unit, and the outer case may include a second lid portion which closes the second opening portion.

According to the above, the second opening portion of the outer case body is arranged at a position facing the energy storage unit and the second opening portion is closed by the second lid portion, so that the second opening portion can be closed by the second lid portion after the energy storage unit is inserted from the second opening portion in an arrangement direction of a plurality of the energy storage devices. By the above, after the energy storage unit is inserted into the outer case body, the second lid portion can close the second opening portion while pressing a plurality of the energy storage devices in the arrangement direction. Therefore, since the energy storage apparatus can be easily assembled, assemblability of the energy storage apparatus can be improved.

(5) In the energy storage apparatus according to any of (1) to (4) described above, the outer case may include a first lid portion which closes the first opening portion, and the second opening portion may be formed to allow the energy storage unit to pass through in a state where the first lid portion closes the first opening portion.

According to the above, the outer case is formed such that the energy storage unit can pass through the second opening portion in a state where the first lid portion closes the first opening portion, the energy storage unit can be inserted from the second opening portion even in a state where the first lid portion closes the first opening portion. By the above, since the energy storage apparatus can be easily assembled, assemblability of the energy storage apparatus can be improved.

(6) In the energy storage apparatus according to any of (1) to (5) described above, the outer case may include a first lid portion that closes the first opening portion and a second lid portion that closes the second opening portion, and the first lid portion and the second lid portion may be joined to the outer case body to seal the inside of the outer case.

According to the above, the inside of the outer case is tightly closed (sealed), so that even in a case where gas is generated in the inside of the outer case, it is possible to prevent gas from leaking to the outside, and it is possible to prevent water from entering the outer case from the outside.

(7) In the energy storage apparatus according to any of (1) to (6) described above, the outer case may include a first lid portion that closes the first opening portion and a second lid portion that closes the second opening portion, and a lid body that collectively closes the first opening portion and the second opening portion.

According to the above, in the outer case, since the lid body collectively closes the first opening portion and the second opening portion with the first lid portion and the second lid portion, it is not necessary to individually close the first opening portion and the second opening portion, and it is possible to improve assemblability of the energy storage apparatus.

(8) In the energy storage apparatus according to any of (1) to (7) described above, each of a plurality of the energy storage devices may include an electrode terminal that protrudes toward the first opening portion.

According to the above, since the electrode terminal of the energy storage device is arranged so as to protrude toward the first opening portion, the electrode terminal of the energy storage device can be accessed from the first opening portion after the energy storage unit is inserted into the outer case body from the second opening portion. By the above, even after the energy storage unit is inserted into the outer case body, the electrode terminal and a bus bar can be joined to each other, and therefore it is unnecessary to join the electrode terminal and the bus bar to each other before the energy storage unit is inserted into the outer case body. Therefore, since the energy storage apparatus can be easily assembled, assemblability of the energy storage apparatus can be improved.

(9) A method of manufacturing an energy storage apparatus according to one aspect of the present invention is a method of manufacturing an energy storage apparatus including an energy storage unit including a plurality of energy storage devices each having a flat shape, and an outer case that accommodates the energy storage unit, the outer case including an outer case body in which a first opening portion opened in a predetermined direction is formed, the outer case body including a bottom wall facing the first opening portion in the predetermined direction, and a side wall integrated with the bottom wall. The method includes causing the energy storage unit to pass through a second opening portion formed at a position facing the side wall of the outer case body to accommodate the energy storage unit in the outer case.

According to the above, in the method of manufacturing the energy storage apparatus, the energy storage unit is accommodated in the outer case by causing the energy storage unit to pass through the second opening portion. By the above, as described above, even in a case where it is difficult to insert the energy storage unit from the first opening portion, the energy storage unit can be inserted from the second opening portion and hence, the energy storage apparatus can be easily assembled. Therefore, it is possible to improve assemblability of the energy storage apparatus.

Hereinafter, the energy storage apparatus according to an embodiment (including a modification example of the embodiment) of the present invention will be described with reference to the drawings. All the embodiments described below illustrate a comprehensive or specific example. Numerical values, shapes, materials, components, arrangement positions and connection modes of the components, manufacturing processes, the order of the manufacturing processes, and the like shown in the embodiment below are merely examples, and are not intended to limit the present invention. In the drawings, dimensions and the like are not strictly illustrated. In the drawings, the same or similar components are denoted by the same reference numerals.

In description below and the drawings, an arrangement direction of a pair of electrode terminals included in an energy storage device, a facing direction of a pair of short side surfaces in a case of the energy storage device, or a longitudinal direction of the energy storage device is defined as an X-axis direction. A facing direction of a pair of long side surfaces of the case of the energy storage device, a thickness direction (flat direction) of the case of the energy storage device, an arrangement direction of a plurality of the energy storage devices, an arrangement direction of the energy storage device and a spacer, an opening direction of a second opening portion of an outer case body, or an arrangement direction of the outer case body and a second lid portion is defined as a Y-axis direction. A protruding direction of the electrode terminal of the energy storage device, an arrangement direction of a case body and a case lid portion of the energy storage device, an opening direction of a first opening portion of the outer case body, a facing direction of a bottom wall of the outer case body, an arrangement direction of the outer case body and a first lid portion, or a vertical direction is defined as a Z-axis direction. The X-axis direction, the Y-axis direction, and the Z-axis direction are directions intersecting (in the present embodiment, orthogonal to) each other. Although a case where the Z-axis direction is not the vertical direction can be considered depending on a usage mode, the Z-axis direction will be described below as the vertical direction for convenience of description.

In description below, an X-axis plus direction indicates an arrow direction of an X axis, and an X-axis minus direction indicates a direction opposite to the X-axis plus direction. Simply referring to the X-axis direction refers to either or both of the X-axis plus direction and the X-axis minus direction. The same applies to the Y-axis direction and the Z-axis direction. Expressions indicating a relative direction or postures, such as parallel and orthogonal, include a case where the direction or posture is not strictly expressed. For example, that two directions are parallel not only means that the two directions are completely parallel, but also means that the two directions are substantially parallel, that is, a difference of, for example, about several percent is included. In description below, expression “insulation” means “electrical insulation”.

### Embodiment

### [1 Description of Energy Storage Apparatus 10]

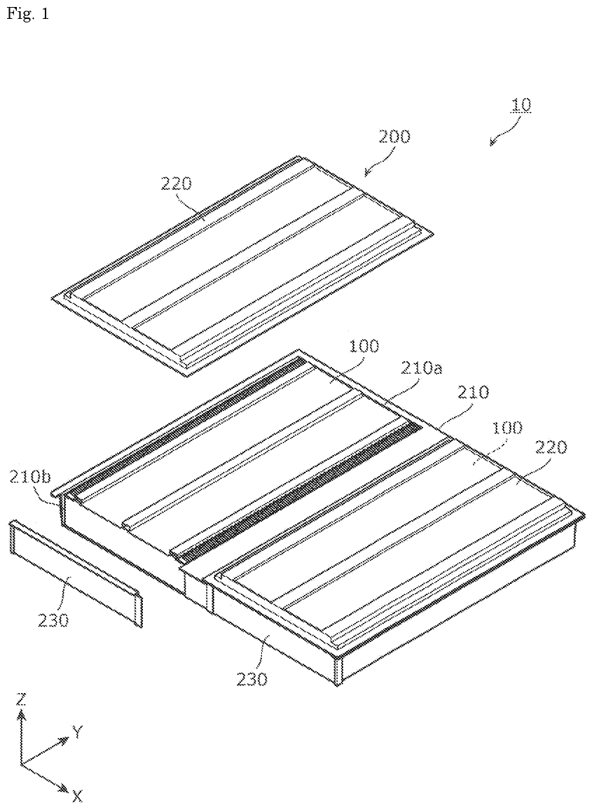

First, a configuration of an energy storage apparatus 10 according to the present embodiment will be described. FIG. 1 is a perspective view illustrating a configuration of the energy storage apparatus 10 according to the present embodiment. FIG. 1 illustrates a state where a first lid portion 220 and a second lid portion 230 in the X-axis plus direction are attached to an outer case body 210 of an outer case 200, and a state where the first lid portion 220 and the second lid portion 230 in the X-axis minus direction are detached from the outer case body 210 in the energy storage apparatus 10. By the above, in FIG. 1, out of two energy storage units 100 arranged inward of the outer case 200, the energy storage unit 100 in the X-axis minus direction is illustrated.

The energy storage apparatus 10 is an apparatus capable of being charged with electricity from the outside and discharging electricity to the outside. The energy storage apparatus 10 is used for energy storage application, power supply application, or the like. Specifically, for example, the energy storage apparatus 10 is used as a battery or the like for driving or starting an engine of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and an automobile of fossil fuel (gasoline, light oil, liquefied natural gas, or the like). Examples of the railway vehicle for an electric railway include a train, a monorail, a linear motor car, and a hybrid train including both a diesel engine and an electric motor. The energy storage apparatus 10 can also be used as a stationary battery or the like used for home use, commercial use, or the like.

As illustrated in FIG. 1, the energy storage apparatus 10 includes the energy storage unit 100 and the outer case 200 in which the energy storage unit 100 is accommodated. The energy storage apparatus 10 also includes external terminals (a positive electrode external terminal and a negative electrode external terminal) and the like for electrical connection with an external apparatus, but illustration and description of the external terminals are omitted. In addition to the above-described component, the energy storage apparatus 10 may also include a circuit board that monitors or controls a charge state, a discharge state, and the like of the energy storage unit 100, an electric device such as a relay, and the like. Hereinafter, a configuration of the energy storage unit 100 and the outer case 200 are described in detail.

### [1.1 Description of Energy Storage Unit 100]

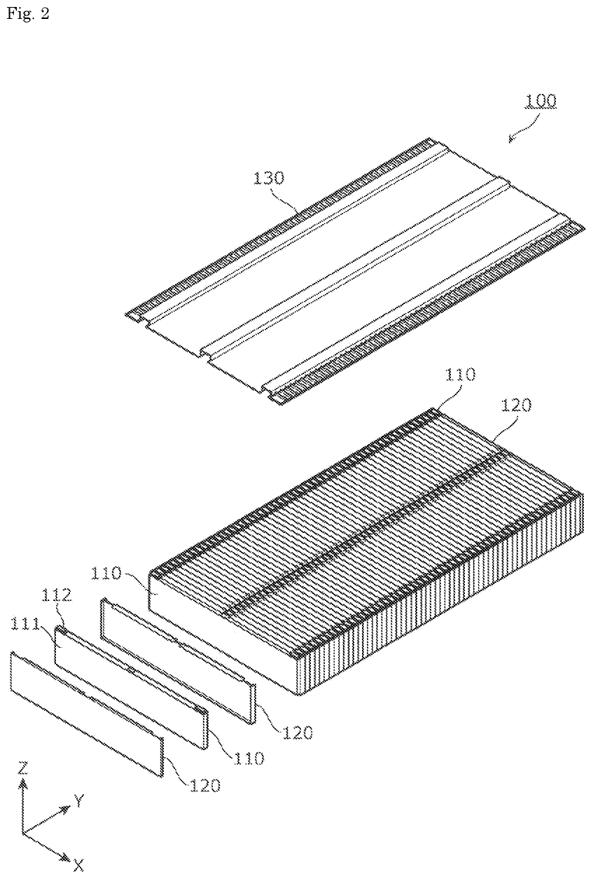

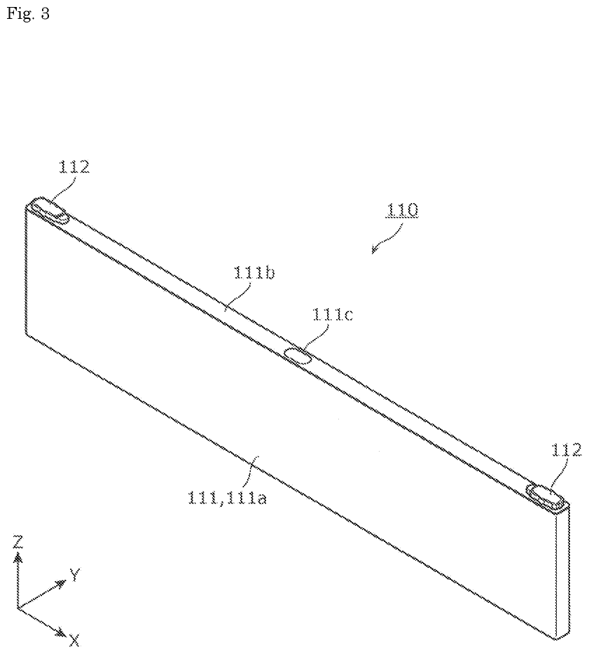

FIG. 2 is an exploded perspective view illustrating each constitution element of the energy storage unit 100 according to the present embodiment. FIG. 3 is a perspective view illustrating a configuration of an energy storage device 110 included in the energy storage unit 100 according to the present embodiment. The energy storage devices 110 included in the energy storage unit 100 all have the same configuration.

The energy storage unit 100 is a battery module (assembled battery) including a plurality of energy storage devices. Specifically, the energy storage unit 100 has a substantially rectangular parallelepiped shape which is long in the Y-axis direction as a plurality of the energy storage devices 110, each having a shape which is flat in the Y-axis direction and is long in the X-axis direction, are arranged in the Y-axis direction. In the present embodiment, two of the energy storage units 100 arranged in the X-axis direction are accommodated inward of the outer case 200.

As illustrated in FIG. 2, the energy storage unit 100 includes a plurality of the energy storage devices 110, a plurality of spacers 120, and a bus bar frame 130. The energy storage unit 100 also includes a bus bar that connects the energy storage devices 110 in series or in parallel, a bus bar that connects the energy storage device 110 and an external terminal, and the like, but illustration of the bus bars is omitted. Note that the energy storage unit only needs to include at least a plurality of the energy storage devices 110, and a case where there is no other member or a case where a change is made corresponds to the energy storage unit.

The energy storage device 110 is a secondary battery (battery cell) capable of being charged with electricity and discharging electricity, and more specifically, is a nonaqueous electrolyte secondary battery such as a lithium ion secondary battery. The energy storage device 110 has a rectangular parallelepiped shape (prismatic shape) which is long in the X-axis direction and flat in the Y-axis direction. In the present embodiment, a plurality of (sixty in FIG. 2) of the energy storage devices 110 are arranged in the Y-axis direction. The number of the arranged energy storage devices 110 is not particularly limited, and may be several, several tens (about twenty), eighty, ninety, or one hundred or more. A size and a shape of the energy storage device 110 are not particularly limited, and may be an oval columnar shape, an elliptic columnar shape, a polygonal columnar shape other than a rectangular parallelepiped shape, or the like which is flat in the Y-axis direction. The energy storage device 110 is not limited to a nonaqueous electrolyte secondary battery, and may be a secondary battery other than a nonaqueous electrolyte secondary battery, or may be a capacitor. The energy storage device 110 does not need to be a secondary battery and may be a primary battery that allows stored electricity to be used without being charged by the user. The energy storage device 110 may be a battery using a solid electrolyte. The energy storage device 110 may be a pouch type energy storage device.

Specifically, as illustrated in FIG. 3, the energy storage device 110 includes a case 111 and a pair of (positive and negative) electrode terminals 112. An electrode assembly, a pair of (positive electrode and negative electrode) current collectors, and an electrolyte solution (nonaqueous electrolyte) are accommodated inward of the case 111, and a gasket is arranged between the electrode terminal 112 and the current collector and the case 111, but these are not illustrated. A kind of the electrolyte solution is not particularly limited as long as the electrolyte solution does not impair performance of the energy storage device 110, and various kinds of electrolyte solution can be selected. The gasket may be formed of any material as long as the material has insulation property. In addition to the above-described component, the energy storage device 110 may include a spacer arranged on a side of the electrode assembly, an insulating film enclosing the electrode assembly and the like, an insulating film (shrink tube and the like) covering an outer surface of the case 111, and the like.

The case 111 is a case having a rectangular parallelepiped shape (prismatic shape or box shape) elongated in the X-axis direction. The case 111 includes a case body 111a on which an opening is formed, and a case lid portion 111b that closes the opening of the case body 111a. The case body 111a is a member including a bottom and a rectangular cylindrical shape structuring a body portion of the case 111, and includes an opening formed in the Z-axis plus direction. The case lid portion 111b is a rectangular plate-like member which structures a lid portion of the case 111 and is long in the X-axis direction, and is arranged in the Z-axis plus direction of the case body 111a. The case lid portion 111b is provided with a gas release valve 111c that, when pressure inward of the case 111 excessively increases, releases the pressure, an electrolyte solution filling unit (not illustrated) for filling the inward of the case 111 with an electrolyte solution, and the like.

The inside of the case 111 is tightly closed (sealed) as the case body 111a and the case lid portion 111b are joined by welding or the like after an electrode assembly and the like are accommodated inward of the case body 111a. By the above, the case 111 is configured to include a pair of long side surfaces which extend in the X-axis direction on both side surfaces in the Y-axis direction, a pair of short side surfaces which extend in the Z-axis direction on both side surfaces in the X-axis direction, a bottom surface which extends in the X-axis direction in the Z-axis minus direction, and an upper surface (terminal arrangement surface) which extends in the X-axis direction in the Z-axis plus direction. A material of the case 111 (the case body 111a and the case lid portion 111b) is not particularly limited, and may be weldable metal such as stainless steel, aluminum, an aluminum alloy, iron, or a plated steel plate, but resin may also be used.

The electrode terminal 112 is a terminal member (a positive electrode terminal and a negative electrode terminal) of the energy storage device 110 arranged on the case lid portion 111b. Specifically, the electrode terminal 112 is arranged in a state of protruding in the Z-axis plus direction from an upper surface (terminal arrangement surface) of the case lid portion 111b. The electrode terminal 112 is electrically connected to a positive electrode plate and a negative electrode plate of an electrode assembly via a current collector. That is, the electrode terminal 112 is a metal member for leading out electricity stored in an electrode assembly to an external space of the energy storage device 110 and also for introducing electricity into an internal space of the energy storage device 110 for storing electricity in the electrode assembly. The electrode terminal 112 is formed of aluminum, an aluminum alloy, copper, a copper alloy, or the like. A shape of the electrode terminal 112 is not particularly limited, and may be formed of, for example, a bolt or the like.

The electrode assembly is an energy storage element (power generating element) formed by stacking a positive electrode plate, a negative electrode plate, and a separator. The positive electrode plate includes a positive active material layer formed on a positive electrode substrate layer which is a current collecting foil made from metal such as aluminum or an aluminum alloy. The negative electrode plate includes a negative active material layer formed on a negative electrode substrate layer which is a current collecting foil made from metal such as copper or a copper alloy. As an active material used for the positive active material layer and the negative active material layer, a publicly-known material can be appropriately used as long as the material can occlude and discharge lithium ions. As the separator, a microporous sheet or nonwoven fabric made from resin can be used. In the present embodiment, the electrode assembly is formed by stacking plates (a positive electrode plate and a negative electrode plate) in the Y-axis direction. The electrode assembly may be an electrode assembly in any form such as a winding-type electrode assembly formed by winding plates (a positive electrode plate and a negative electrode plate), a stacking-type (stack-type) electrode assembly formed by stacking a plurality of plate-shaped plates, or a bellows-type electrode assembly formed by folding a plate in a bellows shape.

The current collector is a current collecting member (positive electrode current collector and negative electrode current collector) that has conductivity and is electrically and mechanically connected to the electrode terminal 112 and the electrode assembly. The positive electrode current collector is formed of aluminum, an aluminum alloy, or the like similarly to the positive electrode substrate layer of the positive electrode plate of the electrode assembly, and the negative electrode current collector is formed of copper, a copper alloy, or the like similarly to the negative electrode substrate layer of the negative electrode plate of the electrode assembly.

The spacer 120 is a flat plate-shaped rectangular member which is arranged side by side with the energy storage device 110 in the Y-axis direction, insulates and/or thermally insulates the energy storage device 110 from another member, is parallel to an XZ plane, and is long in the X-axis direction. The spacer 120 is an insulating plate or a thermally insulating plate which is arranged in the Y-axis plus direction or the Y-axis minus direction of the energy storage devices 110 and insulates and/or thermally insulates the energy storage devices 110 from each other or the energy storage device 110 and the outer case 200 from each other. The spacer 120 is formed of an insulating member such as polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), ABS resin, or a composite material of these, or a member having thermal insulation property such as mica and the like.

Specifically, the spacer 120 is arranged so as to cover an entire surface of a long side surface of the case 111 that the energy storage device 110 includes and about a half of a pair of short side surfaces of the case 111 in the Y-axis direction, a half of an upper surface of the case 111 in the Y-axis direction and a half of a bottom surface of the case 111 in the Y-axis direction. By the above, almost an entire surface of the pair of long side surfaces of the energy storage device 110, the pair of short side surfaces of the energy storage device 110, the upper surface of the energy storage device 110, and the bottom surface of the energy storage device 110 is covered by two of the spacers 120 that interpose the energy storage device 110. As described above, the spacer 120 electrically insulates and/or thermally insulates the energy storage devices 110, and also has a function of a holder that holds the energy storage devices 110 and positions the energy storage devices 110. The spacer 120 located at an end portion in the Y-axis plus direction is arranged between the energy storage device 110 located at an end portion in the Y-axis plus direction and the outer case body 210. The spacer 120 located at an end portion in the Y-axis minus direction is arranged between the energy storage device 110 located at an end portion in the Y-axis minus direction and the second lid portion 230. In the present embodiment, the spacers 120 are alternately arranged side by side in the Y-axis direction with the energy storage device 110, but a configuration in which any of the spacers 120 is not arranged may be employed. All the spacers 120 may be formed of members made from the same material, or any of the spacers 120 may be formed of a member made from a different material.

The bus bar frame 130 is a plate-like and rectangular member (also referred to as a bus bar holder or a bus bar plate) that performs insulation between a bus bar (not illustrated) and another member, position regulation of the bus bar, and the like. The bus bar is a plate-like member connected to the energy storage device 110. The bus bar frame 130 is arranged in the Z-axis plus direction of a plurality of the energy storage devices 110 and positioned with respect to a plurality of the energy storage devices 110, and the bus bar is positioned with respect to the bus bar frame 130, so that the bus bar is positioned with respect to a plurality of the energy storage devices 110. By the above, the bus bar is arranged in the Z-axis plus direction of a plurality of the energy storage devices 110, and is connected (joined) to the electrode terminal 112 included in a plurality of the energy storage devices 110. Specifically, the bus bar connects the electrode terminals 112 of a plurality of the energy storage devices 110 to each other, and electrically connects the electrode terminal 112 of the energy storage device 110 at an end portion to an external terminal.

The bus bar frame 130 is formed of an insulating member such as any resin material that can be used for the spacer 120. The bus bar is formed of a conductive member made from metal such as aluminum, an aluminum alloy, copper, a copper alloy, or nickel, a combination of these, a conductive member other than metal, or the like. The bus bar may connect all the energy storage devices 110 in series, may connect any of the energy storage devices 110 in parallel and then in series, or may connect all the energy storage devices 110 in parallel. The bus bar and the electrode terminal 112 are connected (joined) by welding, a bolt, or the like, but a connection form of them is not particularly limited.

### [1.2 Description of Outer Case 200]

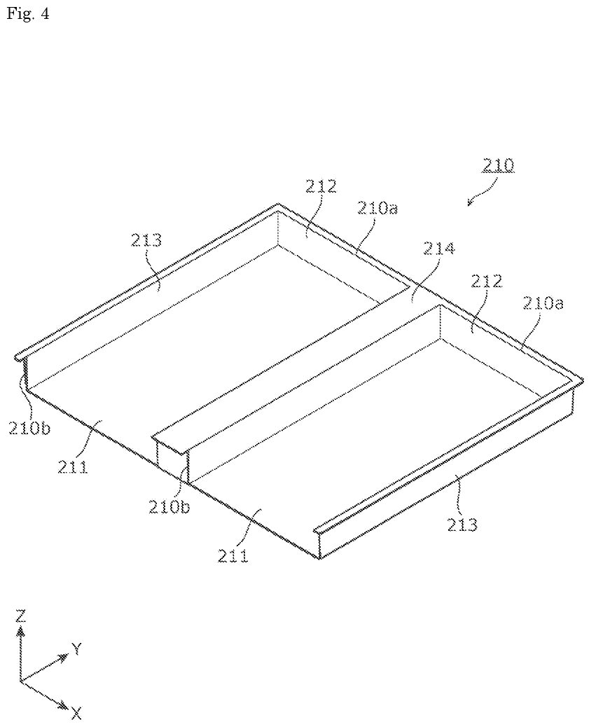

Next, a configuration of the outer case 200 will be described in detail with reference also to FIG. 4. FIG. 4 is a perspective view illustrating a configuration of the outer case body 210 of the outer case 200 according to the present embodiment.

The outer case 200 is a case having a substantially rectangular parallelepiped shape (box shape) which structures an outer case of the energy storage apparatus 10. The outer case 200 is arranged outward of the energy storage unit 100, fixes the energy storage unit 100 at a predetermined position, and protects the energy storage unit 100 from an impact and the like. The outer case 200 is formed of a member made from metal such as aluminum, an aluminum alloy, stainless steel, iron, or a plated steel plate. In the present embodiment, the outer case 200 is formed by die casting aluminum (aluminum die casting). The outer case 200 may be formed by using a casting technique other than die casting. The outer case 200 may be formed of a member having insulating property such as any resin material which can be used for the spacer 120 of the energy storage unit 100 described later.

As illustrated in FIG. 1, the outer case 200 includes the outer case body 210 which structures a body of the outer case 200, and the first lid portion 220 and the second lid portion 230 which form a lid body of the outer case 200. The outer case body 210 is a housing (case body) on which an opening is formed, and accommodates the energy storage unit 100. The first lid portion 220 and the second lid portion 230 are flat rectangular members which close an opening of the outer case body 210. The first lid portion 220 and the second lid portion 230 are joined to the outer case body 210 by screwing with a bolt or the like, welding, bonding, or the like. By the above, the outer case 200 has a structure (a structure in which there is no hole and gas is not leaked, or a waterproof structure) in which the inside is tightly closed (sealed). A terminal block of external terminals (positive electrode external terminal and negative electrode external terminal) may be attached to the first lid portion 220 or the second lid portion 230, and the external terminal may be arranged on the terminal block.

Specifically, as illustrated in FIG. 4, the outer case body 210 includes bottom walls 211 which face toward a predetermined direction (Z-axis direction), and side walls 212 and 213 and a partition wall 214 which face toward a direction (Y-axis direction or X-axis direction) which intersects (in the present embodiment, is orthogonal to) the predetermined direction. That is, the outer case body 210 includes two of the bottom walls 211 on a bottom surface portion in the Z-axis minus direction, includes two of the side walls 212 on a side surface portion in the Y-axis plus direction, includes two of the side walls 213 on a side surface portion on both sides in the X-axis direction, and includes the partition wall 214 at a central portion in the X-axis direction. The outer case body 210 is one member in which two of the bottom walls 211, two of the side walls 212, two of the side walls 213, and the partition wall 214 are integrated. That is, the outer case body 210 is integrally formed by aluminum die casting or the like and is integrally formed as one member (one component).

The bottom wall 211 is a flat plate-like rectangular wall portion which forms a bottom surface of the outer case body 210, is parallel to the XY plane and is long in the Y-axis direction. The bottom wall 211 is arranged to face the energy storage unit 100 in the Z-axis direction. Specifically, the bottom wall 211 is arranged in the Z-axis minus direction of the energy storage unit 100 so as to cover an entire surface in the Z-axis minus direction of the energy storage unit 100, and supports the energy storage unit 100 from the Z-axis minus direction. The bottom wall 211 is integrated with the side walls 212 and 213 and the partition wall 214 in a state of being adjacent to the side walls 212 and 213 and the partition wall 214. In the present embodiment, two of the bottom walls 211 are arranged side by side in the X-axis direction by interposing the partition wall 214.

The side wall 212 is a flat plate-like rectangular wall portion which forms a side surface in the Y-axis plus direction of the outer case body 210, is parallel to the XZ plane, and is long in the X-axis direction. The side wall 212 is a wall portion rising in the Z-axis plus direction from an end portion in the Y-axis plus direction of the bottom wall 211, and is arranged to face the energy storage unit 100 in the Y-axis direction. Specifically, the side wall 212 is arranged in the Y-axis plus direction of the energy storage unit 100 (the spacer 120) so as to cover an entire surface of a surface (a surface of the spacer 120 at an end portion in the Y-axis plus direction) in the Y-axis plus direction of the energy storage unit 100. The side wall 212 is adjacent to the bottom wall 211, the side wall 213, and the partition wall 214. In the present embodiment, two of the side walls 212 are arranged side by side in the X-axis direction by interposing the partition wall 214.

The side wall 213 is a flat plate-like rectangular wall portion which forms a side surface in the X-axis direction of the outer case body 210, is parallel to an YZ plane, and is long in the Y-axis direction. The side wall 213 is a wall portion rising in the Z-axis plus direction from an end portion in the X-axis direction of the bottom wall 211, and is arranged to face the energy storage unit 100 in the X-axis direction. The side wall 213 is adjacent to the bottom wall 211 and the side wall 212. In the present embodiment, two of the side walls 213 are arranged to face each other at both end portions in the X-axis direction of the outer case body 210. The side wall 213 in the X-axis plus direction is arranged in the X-axis plus direction of the energy storage unit 100 so as to cover an entire surface in the X-axis plus direction of the energy storage unit 100 in the X-axis plus direction. The side wall 213 in the X-axis minus direction is arranged in the X-axis minus direction of the energy storage unit 100 so as to cover an entire surface in the X-axis minus direction of the energy storage unit 100 in the X-axis minus direction.

The partition wall 214 is a rectangular parallelepiped wall portion which is long in the Y-axis direction and partitions a space inward of the outer case body 210. The partition wall 214 is a wall portion rising in the Z-axis plus direction from an end portion in the X-axis direction of the bottom wall 211, and is arranged to face the energy storage unit 100 in the X-axis direction. Specifically, the partition wall 214 is arranged between two of the energy storage units 100 arranged in the X-axis direction. By the above, the partition wall 214 is arranged in the X-axis minus direction of the energy storage unit 100 so as to cover an entire surface in the X-axis minus direction of the energy storage unit 100 in the X-axis plus direction. The partition wall 214 is arranged in the X-axis plus direction of the energy storage unit 100 so as to cover an entire surface in the X-axis plus direction of the energy storage unit 100 in the X-axis minus direction. The partition wall 214 is adjacent to the bottom wall 211 and the side wall 212.

By the configuration as described above, in the outer case body 210, a first opening portion 210a which is opened in a predetermined direction (Z-axis direction) and a second opening portion 210b which is opened in a direction (Y-axis direction) which intersects (in the present embodiment, is orthogonal to) the predetermined direction are formed. That is, the side wall 212, the side wall 213, and the partition wall 214 form the first opening portion 210a, and the bottom wall 211, the side wall 213, and the partition wall 214 form the second opening portion 210b.

The first opening portion 210a is a rectangular opening portion which is arranged at a position facing the bottom wall 211 of the outer case body 210, is opened in the Z-axis plus direction, and is long in the Y-axis direction as viewed in the Z-axis direction. That is, the first opening portion 210a is an opening portion where a surface in the Z-axis plus direction of the outer case body 210 is opened. In the present embodiment, two of the first opening portions 210a are arranged side by side in the X-axis direction in a manner corresponding to two of the bottom walls 211 arranged side by side in the X-axis direction.

The second opening portion 210b is a rectangular opening portion which is arranged at a position facing the side wall 212 of the outer case body 210, is opened in the Y-axis minus direction, and is long in the X-axis direction as viewed in the Y-axis direction. That is, the second opening portion 210b is an opening portion where a surface in the Y-axis minus direction of the outer case body 210 is opened. In other words, the second opening portion 210b is an opening portion which opens in an arrangement direction (Y-axis direction) of a plurality of the energy storage devices 110. In the present embodiment, two of the second opening portions 210b are arranged side by side in the X-axis direction in a manner corresponding to two of the side walls 212 arranged side by side in the X-axis direction.

The second opening portion 210b includes an opening area smaller than that of the first opening portion 210a and is formed to have a size that allows the energy storage unit 100 to pass through. As illustrated in FIG. 1, the second opening portion 210b is arranged at a position facing the energy storage unit 100. That is, the second opening portion 210b is arranged at a position facing the energy storage unit 100 in the Y-axis direction, and is formed to have a size that allows the energy storage unit 100 to pass through in the Y-axis direction.

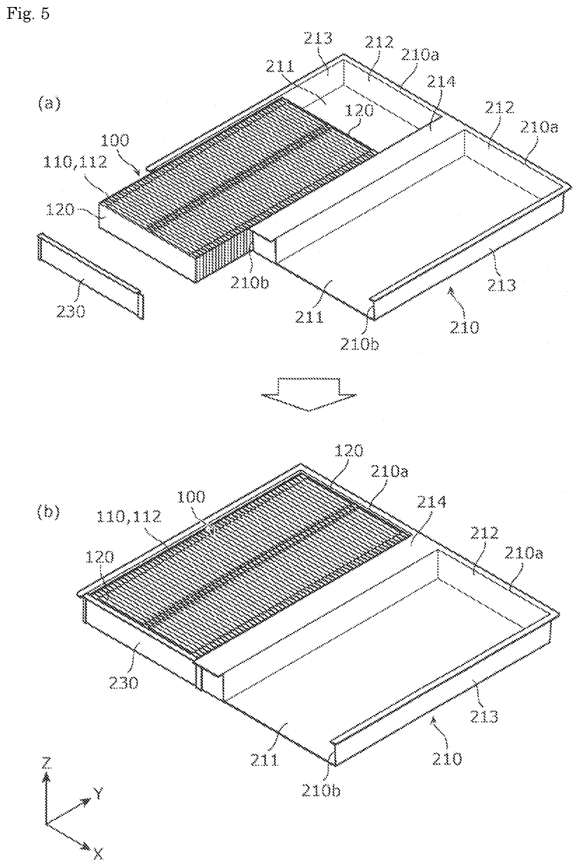

In the present embodiment, similarly, the first opening portion 210a is formed to have a size that allows the energy storage unit 100 to pass through, and is arranged at a position facing the energy storage unit 100. That is, the first opening portion 210a is arranged at a position facing the energy storage unit 100 in the Z-axis direction, and is formed to have a size that allows the energy storage unit 100 to pass through in the Z-axis direction. In the present embodiment, the first opening portion 210a and the second opening portion 210b are connected (linked). That is, the first opening portion 210a and the second opening portion 210b are openings opened in different directions in one large opening. In the prior art document, an energy storage unit can be inserted into an outer case body only from above (Z-axis plus direction). On the other hand, according to the embodiment (for example, FIG. 5), the energy storage unit 100 can be inserted (1) from the first opening portion 210a, that is, from above the outer case body 210 (Z-axis plus direction), (2) from the second opening portion 210b, that is, from a horizontal direction (Y-axis minus direction) of the outer case body 210, and (3) from one large opening formed of the first opening portion 210a and the second opening portion 210b, that is, from obliquely above the outer case body 210. As described above, in inserting the energy storage unit 100 into the outer case body 210, the insertion methods (1) to (3) can be selected.

The first lid portion 220 is a lid body that closes the first opening portion 210a. Specifically, the first lid portion 220 is a flat-plate-like rectangular-shaped member which is parallel to the XY plane and is long in the Y-axis direction, and has a size larger than that of the first opening portion 210a as viewed in the Z-axis direction. The first lid portion 220 is arranged at a position facing the bottom wall 211 in the Z-axis plus direction of the outer case body 210 so as to cover the entire first opening portion 210a, and closes the entire first opening portion 210a. Specifically, the first lid portion 220 closes the first opening portion 210a by being joined in a state of being in contact with the side wall 212, the side wall 213, the partition wall 214, and the second lid portion 230. In the present embodiment, two of the first lid portions 220 are arranged side by side in the X-axis direction in a manner corresponding to two of the first opening portions 210a arranged side by side in the X-axis direction. That is, the first lid portion 220 in the X-axis plus direction closes the first opening portion 210a in the X-axis plus direction, and the first lid portion 220 in the X-axis minus direction closes the first opening portion 210a in the X-axis minus direction.

The second lid portion 230 is a lid body that closes the second opening portion 210b. Specifically, the second lid portion 230 is a flat-plate-like rectangular-shaped member which is parallel to the XZ plane and long in the X-axis direction, and has a size larger than that of the second opening portion 210b as viewed in the Y-axis direction. The second lid portion 230 is arranged at a position facing the side wall 212 in the Y-axis minus direction of the outer case body 210 so as to cover the entire second opening portion 210b and closes the entire second opening portion 210b. Specifically, the second lid portion 230 closes the second opening portion 210b by being joined in a state of being in contact with the bottom wall 211, the side wall 213, the partition wall 214, and the first lid portion 220. In the present embodiment, two of the second lid portions 230 are arranged side by side in the X-axis direction corresponding to two of the second opening portions 210b arranged side by side in the X-axis direction. That is, the second lid portion 230 in the X-axis plus direction closes the second opening portion 210b in the X-axis plus direction, and the second lid portion 230 in the X-axis minus direction closes the second opening portion 210b in the X-axis minus direction.

### [1.3 Description of Method of Manufacturing Energy Storage Apparatus 10]

Next, a process of accommodating the energy storage unit 100 inward of the outer case 200 in the method of manufacturing the energy storage apparatus 10 will be described. FIG. 5 is a diagram illustrating a process of accommodating the energy storage unit 100 according to the present embodiment inward of the outer case 200. Specifically, FIG. 5 (a) illustrates a process of inserting the energy storage unit 100 from the second opening portion 210b of the outer case body 210, and FIG. 5 (b) illustrates a process of closing the second opening portion 210b with the second lid portion 230 after the energy storage unit 100 is inserted into the outer case body 210.

As illustrated in FIG. 5 (a), the second opening portion 210b of the outer case body 210 is formed to have a size that allows the energy storage unit 100 to pass through and hence, as the energy storage unit 100 is allowed to pass through the second opening portion 210b, the energy storage unit 100 is inserted inward of the outer case body 210 from the second opening portion 210b. In the present embodiment, the energy storage unit 100 inserted from the second opening portion 210b is the energy storage unit 100 which includes a plurality of the energy storage devices 110 and a plurality of the spacers 120 in a state where a bus bar and the bus bar frame 130 are not arranged. Specifically, the energy storage unit 100 is inserted inward of the outer case body 210 from the second opening portion 210b in a direction where a plurality of the energy storage devices 110 and a plurality of the spacers 120 are arranged (Y-axis direction). In the present embodiment, the second opening portion 210b is formed to have a size that allows the energy storage unit 100 to pass through even in a state where the first lid portion 220 closes the first opening portion 210a. That is, in a case where a state in which the energy storage unit 100 passes through the second opening portion 210b is viewed from the Y-axis direction, the second opening portion 210b is formed to have a size (a size larger than the energy storage unit 100) in which the energy storage unit 100 does not protrude in the Z-axis plus direction.

As illustrated in FIG. 5 (b), after the energy storage unit 100 is inserted into the outer case body 210 through the second opening portion 210b and accommodated inward of the outer case body 210, the second lid portion 230 is attached to the outer case body 210. At this time, the second lid portion 230 compresses the energy storage unit 100 by pressing a plurality of the energy storage devices 110 and a plurality of the spacers 120 included in the energy storage unit 100 from an arrangement direction (Y-axis direction) of these. As described above, since the spacer 120 is arranged between all the energy storage devices 110, the energy storage unit 100 is configured to be easily pressed (compressed) in the Y-axis direction. By the above, the second lid portion 230 is attached to the outer case body 210 in a state where the energy storage unit 100 is pressed (compressed) in the Y-axis direction, and the second opening portion 210b is closed. In a case where a gap is formed between the energy storage unit 100 and the second lid portion 230 or the side wall 212 of the outer case body 210, a member such as a wedge may be inserted into the gap to fill the gap.

With such a configuration, in a state where the energy storage unit 100 is arranged inward of the outer case body 210, the second opening portion 210b is arranged at a position of facing the energy storage unit 100. Furthermore, the electrode terminal 112 of each of a plurality of the energy storage devices 110 included in the energy storage unit 100 protrudes toward the first opening portion 210a. Then, the bus bar frame 130 is arranged in the Z-axis plus direction of a plurality of the energy storage devices 110, and a bus bar is connected (joined) to the electrode terminal 112 of a plurality of the energy storage devices 110. After the above, the first lid portion 220 is attached to the outer case body 210 and the first opening portion 210a is closed. In this manner, the energy storage unit 100 is accommodated in the outer case 200.

### [2 Description of Effect]

As described heretofore, according to the energy storage apparatus 10 of the present embodiment, the outer case body 210 of the outer case 200 accommodating the energy storage unit 100 including the energy storage device 110 having a flat shape includes the first opening portion 210a, and the bottom wall 211 and the side wall 212 which are integrated. The second opening portion 210b through which the energy storage unit 100 can pass is formed at a position facing the side wall 212 of the outer case body 210. As described above, in the outer case body 210, the second opening portion 210b through which the energy storage unit 100 can pass is formed at a position facing the side wall 212 in addition to the first opening portion 210a which is opened in a direction facing the bottom wall 211. By the above, even in a case where it is difficult to insert the energy storage unit 100 from the first opening portion 210a, the energy storage unit 100 can be inserted from the second opening portion 210b and hence, the energy storage apparatus 10 can be easily assembled. Therefore, it is possible to improve assemblability of the energy storage apparatus 10. According to the energy storage apparatus 10 of the present embodiment, it is possible to easily manufacture the energy storage apparatus 10 (battery pack) called a cell to pack (CTP) type which is housed in the outer case body 210 (battery pack) without unitizing or modularizing a plurality of the energy storage devices 110.

Since the second opening portion 210b of the outer case body 210 is opened in an arrangement direction (Y-axis direction) of a plurality of the energy storage devices 110, the energy storage unit 100 can be inserted from the second opening portion 210b in the arrangement direction and the energy storage unit 100 can be arranged inward of the outer case body 210. By the above, the energy storage unit 100 allows a plurality of the energy storage devices 110 to be inserted into the inside of the outer case body 210 without excessively pressing a plurality of the energy storage devices 110 in the arrangement direction. In a case where the energy storage unit 100 (a plurality of the energy storage devices 110) is inserted from an opening of the outer case body 210 in a state where the energy storage unit 100 (a plurality of the energy storage devices 110) is pressed (in a case where the energy storage unit 100 (a plurality of the energy storage devices 110) is lifted up and inserted from above the outer case body 210, like in a case where the energy storage unit 100 (a plurality of the energy storage devices 110) is inserted into the outer case body 210 of a fixed size whose upper side is opened), facilities such as an arm that can hold the energy storage unit 100 only by pressure frictional force and a holding claw that can withstand pressure force are required, and a size of the energy storage device 110 that can be used is also limited due to a weight. In a case where a plurality of the energy storage devices 110 are pressed and then inserted, predetermined pressure force is applied to the energy storage unit 100, a dimension of the energy storage unit 100 is measured, and a shim corresponding to the dimension is first inserted into the outer case body 210. In this state, it is necessary to further press and insert the energy storage unit 100 into the outer case body 210 and to remove a pressing jig, which is complicated. In operation of inserting the energy storage unit 100 interposed by an arm or the like into the outer case body 210, excessive pressure force is applied to the energy storage unit 100 to compress a dimension of the energy storage unit 100. Therefore, the case 111 of the energy storage device 110 is required to have strength which withstands the pressure force. Therefore, it is necessary to increase materials and cost of the case 111 and other peripheral members in, for example, increasing thickness of a material of the case 111 in the energy storage device 110. On the other hand, in the case of the present configuration, pressure force for pressurizing and compressing the energy storage unit 100 may be small, and damage applied to the energy storage unit 100 (energy storage device 110) by pressurization is small. Since a structure for withstanding excessive pressure force is also not required, it is advantageous in terms of space efficiency and cost reduction. As described above, since the energy storage unit 100 (a plurality of the energy storage devices 110) can be inserted into the inside of the outer case body 210 without being pressed by excessive pressure force, the energy storage apparatus 10 can be easily assembled, and assemblability of the energy storage apparatus 10 can be improved.

The second opening portion 210b of the outer case body 210 is arranged at a position facing the energy storage unit 100, and the second opening portion 210b is closed by the second lid portion 230. By the above, after the energy storage unit 100 is inserted from the second opening portion 210b in an arrangement direction (Y-axis direction) of a plurality of the energy storage devices 110, the second opening portion 210b can be closed by the second lid portion 230. That is, after the energy storage unit 100 is inserted into the outer case body 210, the second lid portion 230 can close the second opening portion 210b while pressing a plurality of the energy storage devices 110 in the arrangement direction. Therefore, since the energy storage apparatus 10 can be easily assembled, assemblability of the energy storage apparatus 10 can be improved.

As the outer case 200 is formed such that the energy storage unit 100 can pass through the second opening portion 210b in a state where the first lid portion 220 closes the first opening portion 210a, the energy storage unit 100 can be inserted from the second opening portion 210b even in a state where the first lid portion 220 closes the first opening portion 210a. By the above, since the energy storage apparatus 10 can be easily assembled, assemblability of the energy storage apparatus 10 can be improved.

Since the electrode terminal 112 of the energy storage device 110 is arranged so as to protrude toward the first opening portion 210a, the electrode terminal 112 of the energy storage device 110 can be accessed from the first opening portion 210a after the energy storage unit 100 is inserted into the outer case body 210 from the second opening portion 210b. By the above, even after the energy storage unit 100 is inserted into the outer case body 210, the electrode terminal 112 and a bus bar can be joined to each other, and therefore it is unnecessary to join the electrode terminal 112 and the bus bar to each other before the energy storage unit 100 is inserted into the outer case body 210. Therefore, since the energy storage apparatus 10 can be easily assembled, assemblability of the energy storage apparatus 10 can be improved.

In the method of manufacturing the energy storage apparatus 110, the energy storage unit 100 is accommodated in the outer case 200 by causing the energy storage unit 100 to pass through the second opening portion 210b. By the above, as described above, even in a case where it is difficult to insert the energy storage unit 100 from the first opening portion 210a, the energy storage unit 100 can be inserted from the second opening portion 210b and hence, the energy storage apparatus 10 can be easily assembled. Therefore, it is possible to improve assemblability of the energy storage apparatus 10.

### [3 Description of Modification Example]

Although the energy storage apparatus 10 and the method of manufacturing the energy storage apparatus 10 according to the embodiment of the present invention are described above, the present invention is not limited to the embodiment described above. The embodiment disclosed herein is an example in all respects, and the scope of the present invention includes all modifications within the meaning and scope equivalent to the claims.

### First Modification Example

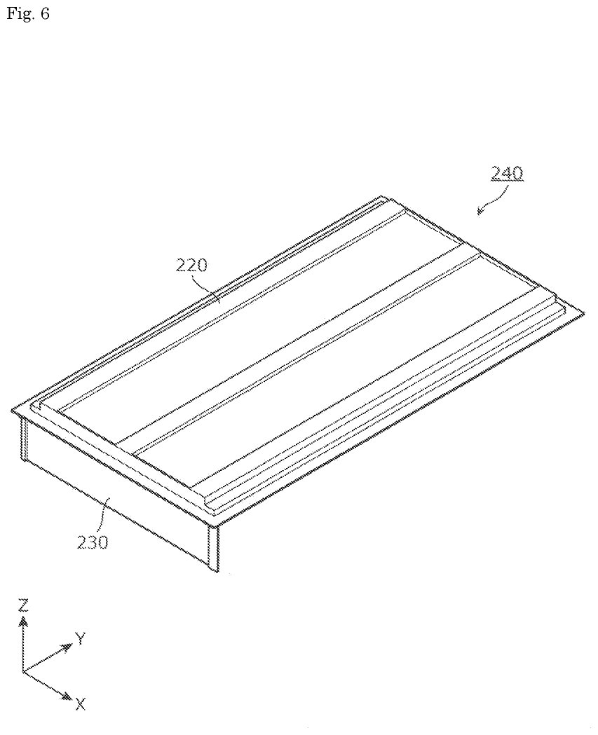

In the above embodiment, the first lid portion 220 and the second lid portion 230 of the outer case 200 are formed as separate bodies, but the first lid portion 220 and the second lid portion 230 may be integrated. FIG. 6 is a perspective view illustrating a configuration of a lid body 240 included in the outer case 200 according to a first modification example of the present embodiment. Specifically, FIG. 6 is a diagram corresponding to the first lid portion 220 and the second lid portion 230 of the outer case 200 illustrated in FIG. 1.

As illustrated in FIG. 6, the outer case 200 in the present modification example includes the lid body 240 in which the first lid portion 220 and the second lid portion 230 are integrated, instead of the first lid portion 220 and the second lid portion 230 which are separate bodies in the embodiment described above. Other configurations of the present modification example are similar to those of the above embodiment, and thus detailed description will be omitted.

The lid body 240 is a lid body included in the outer case 200, includes the first lid portion 220 which closes the first opening portion 210a of the outer case body 210 and the second lid portion 230 which closes the second opening portion 210b of the outer case body 210, and collectively closes the first opening portion 210a and the second opening portion 210b. That is, the lid body 240 is an L-shaped lid plate as viewed in the X-axis direction, and is one member (one component) in which the first lid portion 220 and the second lid portion 230 are integrally molded (integrally formed). The lid body 240 may be integrally molded by aluminum die casting or the like, or may be formed by joining the first lid portion 220 and the second lid portion 230, which are separate bodies, by welding or the like.

As described above, according to the energy storage apparatus 10 according to the present modification example, a similar effect as that of the above embodiment can be obtained. In particular, in the outer case 200, since the lid body 240 collectively closes the first opening portion 210a and the second opening portion 210b with the first lid portion 220 and the second lid portion 230, it is not necessary to individually close the first opening portion 210a and the second opening portion 210b. The lid body 240 can close the first opening portion 210a with the first lid portion 220 while pressing the energy storage unit 100 with the second lid portion 230. By the above, it is possible to improve assemblability of the energy storage apparatus 10.

In the lid body 240, the first lid portion 220 and second lid portion 230 as separate bodies may be connected by a hinge, and the second lid portion 230 may be configured to be rotatable with respect to the first lid portion 220. With this configuration, the second lid portion 230 can open the second opening portion 210b in a state where the first lid portion 220 closes the first opening portion 210a, or the first lid portion 220 can open the first opening portion 210a in a state where the second lid portion 230 closes the second opening portion 210b. Also with this configuration, it is possible to improve assemblability of the energy storage apparatus 10.

### (Other Modification Examples)

In the above embodiment, the outer case body 210 includes the partition wall 214 and the side walls 212 and 213 integrated with the bottom wall 211, but the configuration only needs to be such that the side wall 212 is integrated with the bottom wall 211. That is, the side wall 213 may be separated from the bottom wall 211, or the partition wall 214 may be separated from the bottom wall 211. The outer case body 210 does not have to include the side wall 213 and does not have to include the partition wall 214.

In the above embodiment, two of the second opening portions 210b formed in the outer case body 210 are opening portions where a surface in the Y-axis minus direction of the outer case body 210 is opened. However, the present invention is not limited to this. One or both of two of the second opening portions 210b may be an opening portion where a surface in the Y-axis plus direction of the outer case body 210 is opened. One or both of two of the second opening portions 210b may be an opening portion where a surface in the X-axis direction of the outer case body 210 is opened. That is, the second opening portion 210b may be an opening portion which opens in a direction intersecting an arrangement direction (Y-axis direction) of a plurality of the energy storage devices 110. In this case, the energy storage unit 100 is inserted inward of the outer case body 210 from the second opening portion 210b in a direction (X-axis direction) which intersects an arrangement direction of a plurality of the energy storage devices 110.

In the above embodiment, the second opening portion 210b of the outer case body 210 is arranged at a position facing the energy storage unit 100, but may be arranged at a position not facing the energy storage unit 100. That is, the energy storage unit 100 may be moved in the X-axis direction after being inserted from the second opening portion 210b, so that the energy storage unit 100 is arranged at a position not facing the second opening portion 210b. In this case, the outer case 200 does not need to include the second lid portion 230.

In the above embodiment, a plurality of the energy storage devices 110 are connected to each other by a bus bar after the energy storage unit 100 is inserted inward of the outer case body 210. However, the energy storage unit 100 may be inserted inward of the outer case body 210 after a plurality of the energy storage devices 110 are connected to each other by a bus bar. In this case, the electrode terminal 112 of the energy storage device 110 does not need to protrude toward the first opening portion 210a.

In the above embodiment, the first opening portion 210a and the second opening portion 210b of the outer case body 210 are connected to each other. However, a partition may be provided between the first opening portion 210a and the second opening portion 210b. That is, the second opening portion 210b may be a through hole formed in a side wall in the Y-axis minus direction of the outer case body 210.

In the above embodiment, the first opening portion 210a includes an opening area larger than that of the second opening portion 210b, and is formed to have a size that allows the energy storage unit 100 to pass through, but the present invention is not limited to this. The first opening portion 210a may have the same opening area as that of the second opening portion 210b, or may have an opening area smaller than that of the second opening portion 210b. The first opening portion 210a may be formed to have a size through which the energy storage unit 100 cannot pass.

In the above embodiment, two of the energy storage units 100 arranged in the X-axis direction are accommodated inward of the outer case 200. However, the configuration may be such that three or more of the energy storage units 100 arranged in the X-axis direction are accommodated, or only one of the energy storage unit 100 is accommodated. A plurality of the energy storage units 100 arranged in the Y-axis direction may be accommodated inward of the outer case 200. Even in such cases, the second opening portion 210b only needs to be formed at a position facing the energy storage unit 100 of the outer case body 210.

In the above embodiment, the outer case 200 does not need to include the first lid portion 220. In the above embodiment, the second opening portion 210b does not need to be formed to have a size that allows the energy storage unit 100 to pass through in a state where the first lid portion 220 closes the first opening portion 210a.

In the above embodiment, a portion in the X-axis plus direction and a portion in the X-axis minus direction of the energy storage apparatus 10 both have the above configuration, but any of the portions may have a configuration different from the above. That is, any of two of the second opening portions 210b does not need to have the above configuration. The same applies to other portions.

In the above embodiment, the energy storage unit 100 may include a binding member (end plate, side plate, or the like) which binds a plurality of the energy storage devices 110 and the like. In the energy storage unit 100 or a plurality of the energy storage devices 110, between adjacent ones of a plurality of the energy storage devices 110, a member such as a spacer may be provided for the purpose of cooling, control of reaction force generated between adjacent ones of the energy storage devices 110, size adjustment, and the like. Such a mode is also included in the scope of the present invention.

A mode constructed by optionally combining components included in the above embodiment and the above modification example is also included in the scope of the present invention.

### INDUSTRIAL APPLICABILITY

The present invention can be applied to an energy storage apparatus or the like including an energy storage device such as a lithium ion secondary battery.

### DESCRIPTION OF REFERENCE SIGNS

10: energy storage apparatus
100: energy storage unit
110: energy storage device
111: case
111a: case body
111b: case lid portion
111c: gas release valve
112: electrode terminal
120: spacer
130: bus bar frame
200: outer case
210: outer case body
210a: first opening portion
210b: second opening portion
211: bottom wall
212, 213: side wall
214: partition wall
220: first lid portion
230: second lid portion
240: lid body

1. An energy storage apparatus, comprising:
an energy storage unit including a plurality of energy storage devices having a plurality of flat shapes, respectively; and
an outer case configured to accommodate the energy storage unit comprising an outer case body such that the outer case body has a first opening portion opened in a predetermined direction, a bottom wall facing the first opening portion in the predetermined direction, and a side wall integrated with the bottom wall,
wherein the outer case body of the outer case has a second opening portion formed at a position facing the side wall of the outer case body and configured such that the energy storage unit passes through the second opening portion.

2. The energy storage apparatus according to claim 1, wherein the bottom wall and the side wall are integrally molded as one member by casting.

3. The energy storage apparatus according to claim 1, wherein the second opening portion of the outer case body is opening in an arrangement direction of the plurality of energy storage devices.

4. The energy storage apparatus according to claim 3, wherein the second opening portion of the outer case body is formed at a position facing the energy storage unit, and the outer case includes a second lid portion configured to close the second opening portion.

5. The energy storage apparatus according to claim 1, wherein the outer case includes a first lid portion configured to close the first opening portion, and the second opening portion is configured to allow the energy storage unit to pass through in a state the first opening portion is closed by the first lid portion.

6. The energy storage apparatus according to claim 1, wherein the outer case includes a first lid portion configured to close the first opening portion and a second lid portion configured to close the second opening portion, and the first lid portion and the second lid portion are configured to be joined to the outer case body to seal an inside of the outer case.

7. The energy storage apparatus according to claim 1, wherein the outer case includes a first lid portion configured to close the first opening portion and a second lid portion configured to close the second opening portion, and a lid body configured to close the first opening portion and the second opening portion.

8. The energy storage apparatus according to claim 1, wherein each of the energy storage devices includes an electrode terminal protruding toward the first opening portion of the outer case body.

9. A method of manufacturing an energy storage apparatus, comprising:
providing an outer case comprising an outer case body and configured to accommodate an energy storage unit such that the outer case body has a first opening portion opened in a predetermined direction, a bottom wall facing the first opening portion in the predetermined direction, a side wall integrated with the bottom wall, and a second opening portion formed at a position facing the side wall of the outer case body; and
passing the energy storage unit comprising a plurality of energy storage devices having a plurality of flat shapes respectively through the second opening portion of the outer case body such that the energy storage unit is accommodated in the outer case.

10. The energy storage apparatus according to claim 2, wherein the second opening portion of the outer case body is opening in an arrangement direction of the plurality of energy storage devices.

11. The energy storage apparatus according to claim 10, wherein the second opening portion of the outer case body is formed at a position facing the energy storage unit, and the outer case includes a second lid portion configured to close the second opening portion.

12. The energy storage apparatus according to claim 2, wherein the outer case includes a first lid portion configured to close the first opening portion, and the second opening portion is configured to allow the energy storage unit to pass through in a state the first opening portion is closed by the first lid portion.

13. The energy storage apparatus according to claim 2, wherein the outer case includes a first lid portion configured to close the first opening portion and a second lid portion configured to close the second opening portion, and the first lid portion and the second lid portion are configured to be joined to the outer case body to seal an inside of the outer case.

14. The energy storage apparatus according to claim 2, wherein the outer case includes a first lid portion configured to close the first opening portion and a second lid portion configured to close the second opening portion, and a lid body configured to close the first opening portion and the second opening portion.

15. The energy storage apparatus according to claim 2, wherein each of the energy storage devices includes an electrode terminal protruding toward the first opening portion of the outer case body.

16. The energy storage apparatus according to claim 3, wherein the outer case includes a first lid portion configured to close the first opening portion, and the second opening portion is configured to allow the energy storage unit to pass through in a state the first opening portion is closed by the first lid portion.

17. The energy storage apparatus according to claim 3, wherein the outer case includes a first lid portion configured to close the first opening portion and a second lid portion configured to close the second opening portion, and the first lid portion and the second lid portion are configured to be joined to the outer case body to seal an inside of the outer case.

18. The energy storage apparatus according to claim 3, wherein the outer case includes a first lid portion configured to close the first opening portion and a second lid portion configured to close the second opening portion, and a lid body configured to close the first opening portion and the second opening portion.

19. The energy storage apparatus according to claim 3, wherein each of the energy storage devices includes an electrode terminal protruding toward the first opening portion of the outer case body.

20. The energy storage apparatus according to claim 4, wherein the outer case includes a first lid portion configured to close the first opening portion, and the second opening portion is configured to allow the energy storage unit to pass through in a state the first opening portion is closed by the first lid portion.
